(19) United States
(12) Patent Application Publication
(10) Pub. No.: US 2026/0226863 A1
(43) Pub. Date: Aug. 6, 2026

(54) OXY-FUEL EXPANDER SYSTEM INCLUDING MULTIPLE HEAT EXCHANGERS AND METHOD

(71) Applicant: Nuovo Pignone Tecnologie - S.r.l., Florence (IT)

(72) Inventors: Lorenzo COSI, Firenze (IT); Alessio MILIANI, Firenze (IT); Francesco GAMBERI, Firenze (IT); Simone AMIDEI, Firenze (IT)

(21) Appl. No.: 19/149,358

(22) PCT Filed: Jan. 19, 2024
(86) PCT No.: PCT/EP2024/025036

§ 371 Date: Jul. 18, 2025

(30) Foreign Application Priority Data
Jan. 25, 2023 (IT) 102023000001104

(51) Int. Cl. F02C 7/232

(52) U.S. Cl. CPC F02C 7/232

(57) ABSTRACT

The oxy-fuel expander system comprises a combustor and an expander fluidly coupled to the combustor and rotated by expansion of the pressurized hot combustion gas from the combustor. A high-temperature heat exchanger and a low-temperature heat exchanger are arranged to recover heat from the combustion gas and heat an oxidant stream and a stream of combustion gas recycled towards the combustor and the expander.

### TECHNICAL FIELD

The present disclosure concerns gas expander or gas turbine systems for the generation of power. Embodiments disclosed herein specifically concern oxyfuel expander systems and related methods.

### BACKGROUND ART

Fossil fuels are a major source of chemical energy used for the generation of mechanical power. Fossil fuels are mixed with air and combusted to generate a combustion gas at high pressure and temperature, which is expanded in a turbine or an expander. In the present disclosure the terms turbine and expanders are used as synonyms, i.e., the term expander encompasses also a turbine. The expander converts combustion gas enthalpy into mechanical power available on the output shaft of the expander and used to drive a load, such as a compressor or compressor train, or to rotate an electric generator and convert mechanical power into electric power.

One of the major concerns with regard to combustion of fossil fuels relates to the production of carbon dioxide, a greenhouse gas which is considered one of the main contributors of global warming and climate changes.

In an attempt to reduce the environmental impact of power generation through combustion of fossil fuels, the option of post combustion capture of carbon dioxide has been investigated. Carbon dioxide capture facilities have been developed, to process flue gas exhausted from gas turbines and remove carbon dioxide therefrom, prior to discharging the flue gas in the environment. The cost of a carbon dioxide capturing facility are high, both in term CAPEX, as well as in terms of energy required to run the facility, which reduces the overall thermodynamic efficiency of the system. The percentage of carbon dioxide in flue gas is low; this requires large volumes of flue gas to be processed through the carbon dioxide capturing facility and renders the capturing process particularly inefficient.

In recent years oxy-combustion expanders, also known as oxy-fuel expanders (or oxy-combustion or oxy-fuel turbines), have been developed, which use an oxidant stream consisting mainly of oxygen (O₂) and carbon dioxide (CO₂) instead of air. Oxygen is obtained by separation from ambient air. A portion of flue gas from the gas expander is recycled in the gas expander combustor, such that the working fluid supplied to the combustor mainly consists of oxygen and carbon dioxide and does not include nitrogen. The resulting flue gas mainly consists of water and carbon dioxide. Water is removed from the flue gas by condensation and the part of water-free flue gas, which is not recycled to the combustor, can be efficiently processed in a carbon dioxide capturing unit.

The amount of power generated by a power generation plant or system may require to be finely and quickly adjusted to follow variations of the mechanical load applied to the expander shaft. For instance, when the expander or turbine drives an electric generator connected to an electricity distribution grid, the load applied to the expander may vary depending upon the amount of electric power absorbed by electric loads powered by the electricity distribution grid. The rotary speed of the expander and of the electric generator shall remain constant. A fluctuation of the load shall therefore be balanced by an adjustment of the fuel delivered to the combustor. Similar adjustment requirements may arise also when the expander drives a compressor train or any other driven machine. Fuel flowrate fluctuations must be compensated by adjustment of the oxidant flowrate.

Efforts have been made to make oxy-fuel expanders and turbines reacting faster to load variations. There is still a need to improve oxy-fuel or oxy-combustion expanders in this regard.

### SUMMARY

According to an aspect, disclosed herein is a gas turbine or expander system, in particular an oxy-fuel expander or turbine system, comprising a combustor adapted to combust a fuel and an oxidant and generate pressurized hot combustion gas, and an expander or turbine fluidly coupled to the combustor and rotated by expansion of the pressurized hot combustion gas from the combustor. The system further includes a high-temperature heat exchanger fluidly coupled to the expander and a low-temperature heat exchanger fluidly coupled to the high-temperature heat exchanger. A hot side of the high-temperature heat exchanger and a hot side of the low-temperature heat exchanger are fluidly coupled in sequence and are adapted to receive and cool expanded combustion gas exhausted from the expander. An oxidant supply line is adapted to supply oxidant to the combustor through a cold side of the high-temperature heat exchanger. In use the oxidant streaming through the high-temperature heat exchanger is in heat exchange with combustion gas exhausted from the expander. A fuel supply line is adapted to supply fuel to the combustor. A combustion gas compressor is adapted to compress combustion gas streaming from the low temperature heat exchanger. Moreover, a recycle line is provided, for recycling a combustion gas stream from the combustion gas compressor through the low-temperature heat exchanger and to the combustor. The recycle line extends through a recycle cold side of the low-temperature heat exchanger in heat exchange with the hot side of the low-temperature heat exchanger.

A first oxidant control valve is arranged in the oxidant supply line upstream of the high-temperature heat exchanger. As will become clear from the description of embodiments, by splitting heat exchange function, efficient heat recovery from the flue gas discharged by the expander or turbine is achieved, in combination with enhanced speediness in the control of the expander, e.g., in case of load variations on the expander shaft.

As mentioned above, the term “expander” as understood herein encompasses any turbomachine adapted to expand process gas and convert enthalpy contained in the process gas into useful mechanical power. Thus, the term expander also encompasses a turbine.

As described in more detail below, the system can further comprise a condenser, where combustion gas from the low-temperature heat exchanger is further chilled to condense steam contained therein. The condenser can be part of a water removal arrangement fluidly coupled to the low-temperature heat exchanger and adapted to receive cooled combustion gas therefrom and remove water from the cooled combustion gas by condensation of the steam contained in the combustion gas and separation of the water from the carbon dioxide, e.g., in a water/gas separator.

Downstream of the water removal arrangement the recycle line branches from a combustion gas removal line. A first combustion gas stream flows through the recycle line towards the low-temperature heat exchanger, where the recycled first combustion gas stream is heated by heat exchange against hot combustion gas from the expander and is delivered as process gas to the combustor. A second combustion gas stream is discharged through the combustion gas removal line, towards a carbon dioxide capturing unit, for instance.

According to a further aspect, disclosed herein is method for operation of an expander system, the method comprising the following steps:
providing a fuel stream to a combustor through a fuel supply line;
providing an oxidant stream to the combustor through a high-temperature heat exchanger;
combusting fuel from the fuel supply line and oxidant in the combustor and generating a stream of pressurized hot combustion gas;
expanding the combustion gas in an expander and generating mechanical power therewith;
discharging exhaust combustion gas from the expander;
flowing the exhaust combustion gas through the high-temperature heat exchanger in heat exchange with the oxidant stream;
flowing the exhaust combustion gas from the high-temperature heat exchanger through a low-temperature heat exchanger in heat exchange with a stream of recycle combustion gas; and
adjusting the oxidant flow by a first oxidant control valve (19) arranged in the oxidant supply line (13) upstream of the high-temperature heat exchanger (22).

Further features and embodiments of oxy-fuel turbine or expander systems and methods according to the present disclosure are described below, reference being made to the attached drawings, and are further set forth in the appended claims.

### BRIEF DESCRIPTION OF THE DRAWINGS

Reference is now made briefly to the accompanying drawings, in which:

FIG. 1 is a schematic of an oxy-fuel expander system according to the present disclosure in one embodiment;

FIG. 2 is a schematic of an oxy-fuel expander system according to the present disclosure in a second embodiment;

FIG. 3 is a schematic of an oxy-fuel expander system according to the present disclosure in a third embodiment;

FIG. 4 is a schematic of an oxy-fuel expander system according to the present disclosure in a fourth embodiment; and

FIG. 5 is a flowchart summarizing a method according to the present disclosure.

### DETAILED DESCRIPTION

To improve the response time of an oxy-fuel turbine or expander in case of variations of the load applied to the expander shaft, the volume of oxidant between an oxidant control valve and the combustor of the expander is reduced by providing a heat exchanger system which includes a first, high-temperature heat exchanger and a second, low-temperature heat exchanger. Both heat exchangers are adapted to remove heat from the combustion gas exhausted from the expander and transferring the waste heat to the oxidant and to a stream of recycled combustion gas. By splitting heat recovery in two heat exchangers, an oxidant control valve can be located along the oxidant supply line in a position nearer to the combustor, such that the total volume of the oxidant supply line between the oxidant control valve and the combustor is minimized, while efficient heat recovery is maintained. This makes the system reacting faster to load variations, as will become more apparent from the following detailed description of some embodiments of the system.

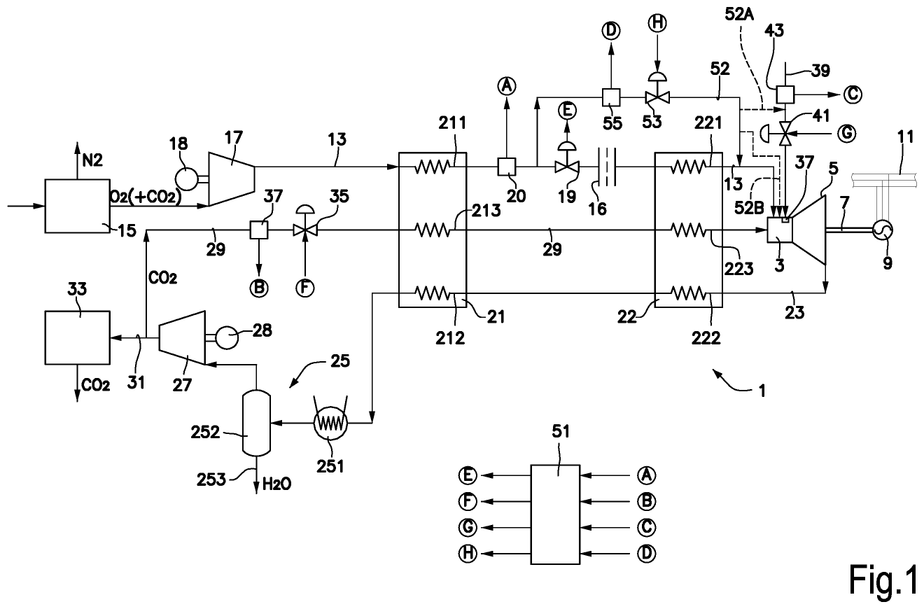

Turning now to the drawings, FIG. 1 shows the schematic of an oxy-fuel expander system 1 according to a first embodiment. The oxy-fuel expander system 1 includes a combustor 3 fluidly coupled to an expander or expander 5. The expander 5 generates mechanical power by expansion of combustion gas generated in the combustor and is drivingly coupled through a shaft 7 to a load 9. The load 9 is driven into rotation by mechanical power generated by the expander 5. In the exemplary embodiment of FIG. 1 the load 9 includes an electric generator, electrically coupled to an electricity distribution grid 11. In other embodiments, not shown, the load may include rotary machines, such as turbomachines, e.g., compressors or pumps, instead of an electric generator or in combination therewith.

An oxidant stream is supplied to the combustor 3 through an oxidant supply line 13. The oxidant stream consists mainly of oxygen or a mixture of oxygen and carbon dioxide. The oxidant may be supplied by any oxidant source. In FIG. 1 an oxidant source includes an air separation unit 15, which separates oxygen, or a blend of oxygen and carbon dioxide, from ambient air, removing nitrogen, or nitrogen and carbon dioxide therefrom. The oxidant stream from the oxidant source 15 can be pressurized in an oxidant compressor 17 to reach a pressure required for supplying the oxidant to the combustor 3. The oxidant compressor 17 can be driven by a driver, such as an electric motor 18. The electric motor 18 can be powered by electric power from the electricity distribution grid 11. In other embodiments, not shown, the oxidant compressor 17 can be driven directly by the expander 5. In such case the oxidant compressor 17 may be part of the load drivingly coupled to the expander shaft 7.

In some embodiments, carbon dioxide can be blended with oxygen in the oxidant supply line or in the oxidant source 15, such that the oxidant flow contains a reduced amount of oxygen, for instance around 20% in volume of oxygen.

A first oxidant control valve 19 is arranged along the oxidant supply line 13, between the oxidant compressor 17 and the combustor 3. The first oxidant control valve 19 is adapted to control the oxidant flowrate through the oxidant supply line 13 towards the combustor 3. A first oxidant flowmeter 20 can be arranged along the oxidant supply line 13, to detect the oxidant flowrate streaming through the oxidant supply line 13 to the combustor 3. An orifice 16 or another flow stabilizing device, which provides a concentrated pressure loss along the oxidant supply line 13, can be arranged downstream the first oxidant control valve 19.

The oxidant stream supplied through the oxidant supply line 13 flows through a cold side 211 of a first, low-temperature heat exchanger 21 in heat exchange with combustion gas (flue gas) exhausted from the expander 5. The combustion gas exhausted from the expander 5 flows through a hot side 212 of the low-temperature heat exchanger 21. Waste heat is thus recovered from the combustion gas to heat the oxidant prior to deliver the latter to the combustor 3, as explained in more detail below.

The hot side 212 of the low-temperature heat exchanger 21 has an inlet fluidly coupled to a hot side 222 of a second, high-temperature heat exchanger 22. The hot side 222 of the high-temperature heat exchanger 22 is fluidly coupled to the discharge of the expander 5 through a combustion gas discharge line 23. The high-temperature heat exchanger 22 further includes a cold side 221, which has an inlet fluidly coupled to the outlet of the cold side 211 of the low-temperature heat exchanger 21 and an outlet which is fluidly coupled to the combustor 3. The high-temperature heat exchanger 22 provides for further waste heat recovery from the flue gas discharged by the expander or turbine 5.

The first oxidant control valve 19 is arranged between the low-temperature heat exchanger 21 and the high-temperature heat exchanger 22.

More in detail, the oxidant supply line 13 extends sequentially through the cold side 211 of the low-temperature heat exchanger 21 and through the cold side 221 of the high-temperature heat exchanger 22 prior to connecting to the combustor 3. In this way, oxidant from the oxidant source 15 is heated by waste heat recovered from the combustion gas (flue gas) streaming from the expander 5 by heat exchange in the low-temperature heat exchanger 21, and is further heated to a higher temperature by waste heat recovered from the combustion gas in the high-temperature heat exchanger 22.

The first oxidant control valve 19 is located between the low-temperature heat exchanger 21 and the high-temperature heat exchanger 22, such that oxidant flowing through the first oxidant control valve 19 is still at a relatively low temperature and volume.

Since the first oxidant control valve 19 is arranged downstream of the low-temperature heat exchanger 21 and upstream of the high-temperature heat exchanger 22, the total volume of oxidant contained in the oxidant supply line 13 downstream of the first oxidant control valve 19, between this latter and the combustor 3, is smaller than if the whole heat were recovered in a single or multiple waste heat recovery heat exchanger fully arranged downstream of the first oxidant control valve 19, as in systems of the current art. This results in beneficial effects in terms of expander control during transients, as will be explained in greater detail below, without reducing the thermal efficiency of the system.

The outlet of the hot side 212 of the low-temperature heat exchanger 21 is fluidly coupled to a water removal arrangement 25, adapted to remove water from the cooled combustion gas discharged from the hot side 212 of the low-temperature heat exchanger 21.

In the schematic of FIG. 1, the water removal arrangement 25 comprises a condenser 251 and a water/gas separator 252. The combustion gas flowing through the condenser 251 is chilled, such that steam contained in the combustion gas condenses, separates from the gas in the water/gas separator 252 and is removed through a water removal line 253.

Since the oxidant fed to the combustor 3 mainly consists of oxygen or a blend of oxygen and carbon dioxide and the oxidant and fuel flowrates are controlled to maintain a stoichiometric combustion in combustor 3, the resulting flue gas exhausted from the expander 5 consists mainly of carbon dioxide and water. The latter is removed by the water removal arrangement 25. The chilled combustion gas exhausted from the water/gas separator 252 consists, therefore, mainly of carbon dioxide.

The chilled combustion gas from the water/gas separator 252 is compressed by a combustion gas compressor 27 and split into a first chilled combustion gas stream and a second chilled combustion gas stream. The combustion gas compressor 27 can be driven by the expander 5 or by a driver 28, such as an electric motor, which can be powered by electric power from the electricity distribution grid 11, for instance.

A first chilled combustion gas stream delivered by the water/gas separator 25 is recycled through a recycle line 29 to the combustor 3. The recycle line 29 extends through the low-temperature heat exchanger 21 and the high-temperature heat exchanger 22. The recycle line 29 branches from a combustion gas removal line 31 fluidly coupled to the discharge side of the combustion gas compressor 27.

In the embodiment of FIG. 1, the combustion gas removal line 31 is fluidly coupled to a carbon dioxide capturing unit 33, which processes a second chilled combustion gas stream delivered from water/gas separator 252, e.g., to store carbon dioxide and avoid discharge thereof in the environment.

The first chilled combustion gas stream, which is recycled through the recycle line 29, streams through a recycle cold side 213 of the low-temperature heat exchanger 21 in heat exchange with the hot side 212, to remove waste heat from the hot combustion gas exhausted from the expander 5 and flowing through the hot side 212 of the low-temperature heat exchanger 21. The partly heated recycled combustion gas stream discharged from the recycle cold side 213 of the low-temperature heat exchanger 21 streams through a recycle cold side 223 of the high-temperature heat exchanger 22, to further remove waste heat from the combustion gas streaming through the hot side 222 of the high-temperature heat exchanger 22. Finally, the heated recycle combustion gas is delivered from the recycle cold side 223 of the high-temperature heat exchanger 22 to the combustor 3, where it is blended with the oxidant delivered through the oxidant supply line 13.

The flowrate of combustion gas recycled through the recycle line 29 can be adjusted by a recycling combustion gas control valve 35 arranged in the recycle line 29. A recycling combustion gas flowmeter 37 can be positioned in the recycle line 29, to detect the flowrate of combustion gas recycling towards the combustor 3.

A side stream of carbon dioxide can be branched off from the recycle line 29 or from the dehydrated carbon dioxide flow upstream of the compressor 27, and added to the oxygen stream from the oxidant source 15. As mentioned above, the percentage of oxygen in the line 13 and/or in the line 53 can be reduced to around 20% by volume for the sake of easier handling.

The oxidant stream fed to the combustor 3 through the oxidant supply line 13 and the recycled combustion gas supplied to the combustor 3 through the recycle line 29 are mixed with fuel, for instance a gaseous fuel, supplied through a fuel supply line 39 to one or more fuel nozzles 37 in the combustor 3. A fuel control valve 41 along the fuel supply line 39 is adapted to adjust the fuel flowrate delivered to the combustor 3. A fuel flowmeter 43 in the fuel supply line 39 can detect the flowrate of the fuel supplied to the combustor 3.

The mechanical power required to rotate the electric generator 9 may fluctuate as a result of fluctuations in the electric power absorbed by electric loads (not shown) connected to the electricity distribution grid 11, for instance. Since the rotary speed of the expander 5 and of the electric generator 9 shall remain constant, a fluctuation of the load must be balanced by accordingly adjusting the fuel flowrate, to prevent angular accelerations or decelerations of the expander 5 and of the electric generator 9. The fuel flowrate must be adjusted as fast and finely as possible by the fuel control valve 41, under the control of a control unit 51. The latter is functionally coupled to the flowmeters 20, 37, 43 and to the control valves 19, 35 and 41.

As mentioned above, the oxidant and fluid molar ratio in the combustor 3 is controlled to maintain stoichiometric combustion conditions and avoid residual fuel or residual oxidant in the combustion gas exhausted from the expander 5. To maintain a stoichiometric ratio in the combustor 3, a change in the fuel flowrate shall be accompanied by a prompt adjustment of the oxidant flowrate.

The volume between the first oxidant control valve 19 and the combustor 3 includes the cold side 221 of the high-temperature heat exchanger 22 but not the cold side 211 of the low-temperature heat exchanger 22. Said volume is therefore minimized compared to systems where a single, large heat exchanger is provided. Faster reaction of the expander 5 to load transients is thus obtained.

To provide an even faster and finer adjustment of the oxidant flowrate during load transients, the system 1 of FIG. 1 further includes at least one oxidant bypass line 52 branched from the oxidant supply line 13 between the low-temperature heat exchanger 21 and the first oxidant control valve 19. The downstream end of the oxidant bypass line 52 is fluidly coupled to the oxidant supply line 13 between the high-temperature heat exchanger 22 and the combustor 3, or to the fuel supply line 39 (see 52A), or directly to the combustor 3 (see 52B), thus bypassing the high-temperature heat exchanger 22. A second oxidant control valve 53 and an optional second oxidant flowmeter 55 are located in the oxidant bypass line 52 and are functionally coupled to the control unit 51. When a fine and prompt adjustment of the oxidant flowrate is required, the control unit 51 causes opening or closing of the second oxidant control valve 53.

The second oxidant control valve 53 is placed near the combustor 3, such that the volume between the second oxidant control valve 53 and the combustor 3 is minimized. The actuation of the second oxidant control valve 53 causes fast and accurate adjustment of a supplemental oxidant flowrate through the oxidant bypass line 52.

During an expander load transient the total oxidant flowrate can be modulated by opening or closing the second oxidant control valve 53 to rapidly increase or de-crease the oxidant flowrate. A slower and coarser adjustment of the oxidant flowrate can be obtained acting upon the first oxidant control valve 19.

In some embodiments, for instance, a sudden change of the load applied to the expander 5 calls for fast adjustment of the fuel flowrate through the fuel supply line 39, controlled by the fuel control valve 41. To maintain stoichiometric fuel/oxidant ratio in the combustor 3, the second oxidant control valve 53 is controlled to obtain fast modulation of the supplemental oxidant flowrate towards combustor 3. Once the load transient has ended and the new load value is stabilized, the second oxidant control valve 53 gradually returns to the condition prior to the load change, synchronously to a modulation of the first oxidant control valve 19. For instance, if the load applied to the expander 5 increases from a lower level to a higher level, the stoichiometric combustion ratio is maintained by fast opening of the second oxidant control valve 53. A subsequent slow adjustment will bring back the second oxidant control valve 53 to the original condition, with a consequent reduction of the supplemental oxidant flowrate through the oxidant bypass line 52, while the first oxidant control valve 19 gradually opens to balance the reduction of flowrate through the oxidant bypass line 52.

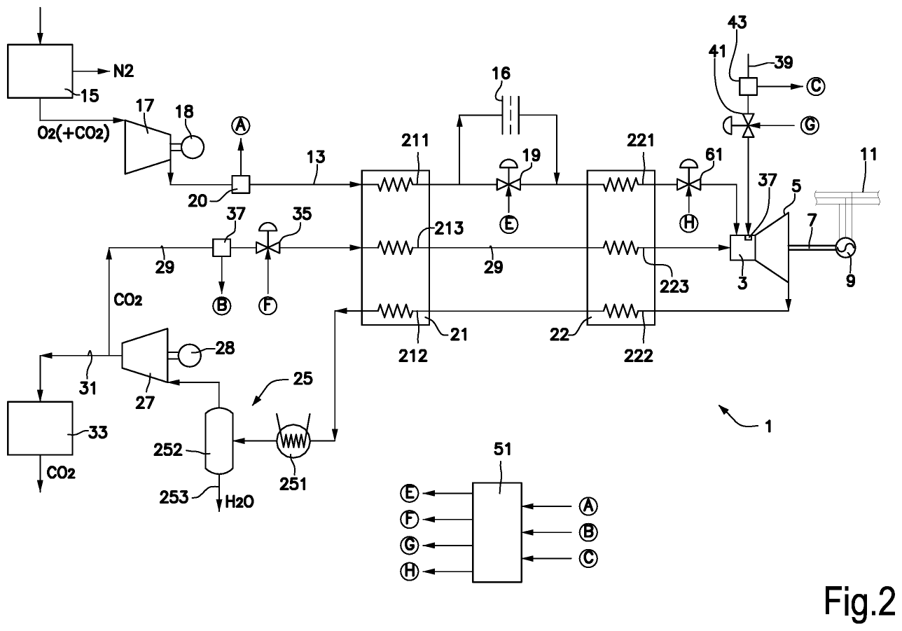

With continuing reference to FIG. 1, a second embodiment of a turbine or expander system 1 is illustrated in FIG. 2. The same reference numbers designate the same or equivalent components already disclosed in FIG. 1 and described above, which will not be described in detail again.

The main difference between the embodiment of FIG. 1 and FIG. 2 is that the system 1 of FIG. 2 does not include an oxidant bypass line 52.

Additionally, the orifice or other flow stabilizing device 16 is positioned in parallel to the first oxidant flow control valve 19 rather than in series therewith.

Moreover, in the embodiment of FIG. 2 a shut-off valve 61 or a second oxidant control valve 61 can be arranged along the oxidant supply line 13, downstream of the high-temperature heat exchanger 22.

In some embodiments, if a second oxidant control valve 61 is combined with the first oxidant control valve 19, the first oxidant control valve 19 can be a pressure-controlled valve, that is opened or closed based on a pressure signal. The second oxidant control valve 61 can be a flowrate-controlled valve. The flowrate-controlled oxidant control valve 61 can be located adjacent or near the combustor 3, since the heat exchanging surfaces of the heat exchangers 21, 22 are arranged upstream the second oxidant control valve 61. The oxidant volume between the second oxidant control valve 61 and the combustor 3 is therefore minimized and this makes the response of the system to load variations faster. In case of load change, the flowrate-controlled oxidant control valve 61 opens or closes, as the case may be, to maintain stoichiometric combustion in the combustor 3 following opening or closing of the fuel control valve 41. The first, pressure-controlled oxidant control valve 19 will then provide a slower adaptation to the new load and oxidant flow conditions.

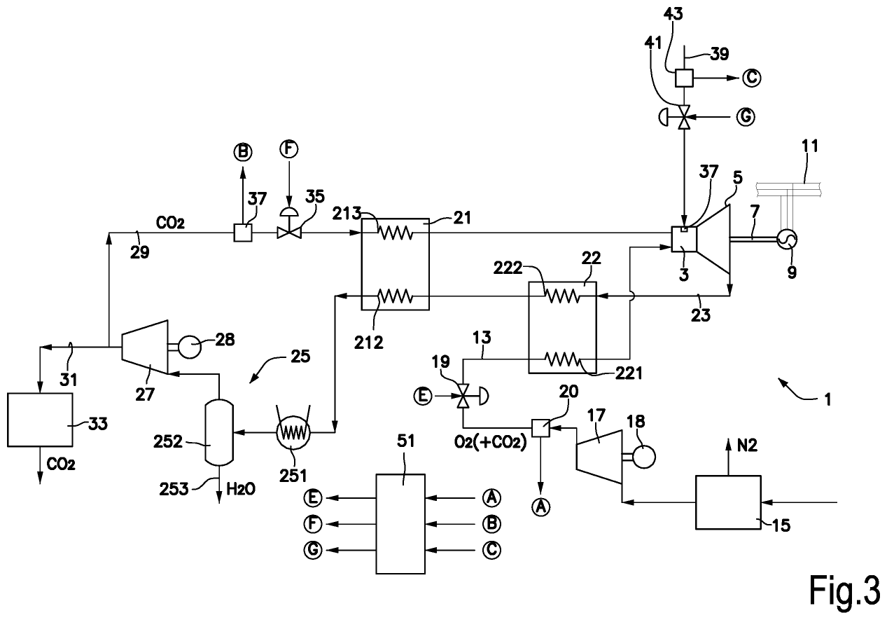

With continuing reference to FIGS. 1 and 2, a further embodiment of an oxy-fuel expander system 1 is illustrated in FIG. 3. The main difference between the embodiment of FIG. 3 and the embodiments of FIGS. 1 and 2 is that the oxidant stream flows through the high-temperature heat exchanger only, while the recycle combustion gas flows through the low-temperature heat exchanger only. The combustion gas exhausting from the expander flows through the hot side of both the high-temperature heat exchanger and the low-temperature heat exchanger.

More specifically, in FIG. 3 an expander or turbine system 1 includes a combustor 3 fluidly coupled to an expander or turbine 5. The expander 5 generates mechanical power and is drivingly coupled through a shaft 7 to a load 9. In the exemplary embodiment of FIG. 3 the load 9 includes an electric generator, electrically coupled to an electricity distribution grid 11. In other embodiments, the load 9 can include a turbomachine, such as a c compressor or a compressor train. In yet further embodiment, the load may include more rotary machines, for instance a combination of electric generator(s) and turbomachine(s), e.g., compressors or pumps.

An oxidant stream is supplied to the combustor 3 through an oxidant supply line 13. The oxidant may be supplied by any oxidant source 15, for instance an air separator that separates oxygen, or a blend of oxygen and carbon dioxide, from ambient air, removing nitrogen, or nitrogen and carbon dioxide, therefrom. The oxidant stream from the oxidant source 15 can be pressurized in an oxidant compressor 17 to achieve a pressure required for supplying the oxidant in the combustor 3. The oxidant compressor 17 can be driven by a driver, such as an electric motor 18. The electric motor 18 can be powered by electric power from the electricity distribution grid 11. In other embodiments, not shown, the oxidant compressor 17 can be driven directly by the expander 5.

An oxidant control valve 19, which is arranged along the oxidant supply line 13 between the oxidant compressor 17 and the combustor 3, is adapted to control an oxidant flowrate through the oxidant supply line 13 towards the combustor 3. An oxidant flowmeter 20 can be arranged along the oxidant supply line 13, to detect the oxidant flowrate streaming through the oxidant supply line 13 to the combustor 3.

The oxidant stream supplied through the oxidant supply line 13 flows through a cold side 221 of a high-temperature heat exchanger 221 in heat exchange with combustion gas (flue gas) exhausted from the expander 5, to recover waste heat therefrom. The combustion gas exhausted from the expander 5 flows through a hot side 222 of the high-temperature heat exchanger 21.

The outlet of the hot side 222 of the high-temperature heat exchanger 22 is fluidly coupled to a hot side 212 of a low-temperature heat exchanger 212, which is adapted to further recover waste heat from the exhausted combustion gas and increase the temperature of a recycle flow of combustion gas as will be described in more detail below.

The outlet of the hot side 212 of the low-temperature heat exchanger 21 is fluidly coupled to a water removal arrangement 25 adapted to remove water from the cooled combustion gas discharged from the hot side 212 of the low-temperature heat exchanger 21. In the schematic of FIG. 3, the water removal arrangement 25 comprises a condenser 251 and a water/gas separator 252. The combustion gas flowing through the condenser 251 is chilled, such that steam contained in the combustion gas condenses, separates from the gas in the water/gas separator 252 and is removed through a water removal line 253. The chilled combustion gas exhausted from the water/gas separator 252 consists mainly of carbon dioxide.

The chilled combustion gas from the water/gas separator 252 is compressed by a combustion gas compressor 27 and split into a first chilled combustion gas stream and a second chilled combustion gas stream. The combustion gas compressor 27 can be driven by the expander 5 or by a driver 28, such as an electric motor, which can be powered by electric power from the electricity distribution grid 11, for instance.

A first chilled combustion gas stream delivered by the water/gas separator 25 is recycled through the low-temperature heat exchanger 21 and towards the combustor 3 through a recycle line 29. The recycle line 29 branches from a combustion gas removal line 31. In the embodiment of FIG. 3 the combustion gas removal line 31 is fluidly coupled to a carbon dioxide capturing unit 33, which processes a second chilled combustion gas stream delivered from the water/gas separator 252, e.g., to store carbon dioxide and avoid discharge thereof in the environment.

The first chilled combustion gas stream, which is recycled through the recycle line 29, streams through a recycle cold side 213 of the low-temperature heat exchanger 21 in heat exchange relationship with the hot side 212, to remove waste heat from the hot combustion gas exhausted from the expander 5 and is delivered to the combustor 3, where it is blended with the oxidant delivered through the oxidant supply line 13.

The flowrate of combustion gas recycled through the recycle line 29 can be adjusted by a recycling combustion gas control valve 35. A recycling combustion gas flowmeter 37 can be provided along the recycle line 29, to detect the flowrate of combustion gas recycling towards the combustor 3.

The oxidant stream fed to the combustor 3 through the oxidant supply line 13 and the recycled combustion gas supplied to the combustor 3 through the recycle line 29 are mixed with fuel, for instance a gaseous fuel, supplied to one or more fuel nozzles 37 in the combustor 3, through a fuel supply line 39. A fuel control valve 41 along the fuel supply line 39 is adapted to adjust the flowrate of fuel delivered to the combustor 3. A fuel flowmeter 43 along the fuel supply line 39 can detect the flowrate of the fuel supplied to the combustor 3.

Adjustment of the oxidant flowrate to balance fuel flowrate variations during load transients is performed acting on the oxidant control valve 19. In a way similar to the previously described embodiments, the volume between the oxidant control valve 19 and the combustor 3 is minimized, since the heat recovery function is performed by two separate heat exchangers 21 and 22. The reduced volume between oxidant control valve 19 and combustor 3 enhances control and operability of the expander, similarly to the previously described embodiments shown in FIGS. 1 and 2.

The option of providing two oxidant flow control valves, respectively upstream and downstream of high-temperature heat exchanger 22, similarly to the embodiment of FIG. 2, is not excluded. In this case, an additional, second oxidant control valve can be located between the cold side 221 of the high-temperature heat exchanger 22 and the combustor 3. The second oxidant control valve can be a flowrate-controlled valve, while the oxidant control valve 19 can be a pressure-controlled valve.

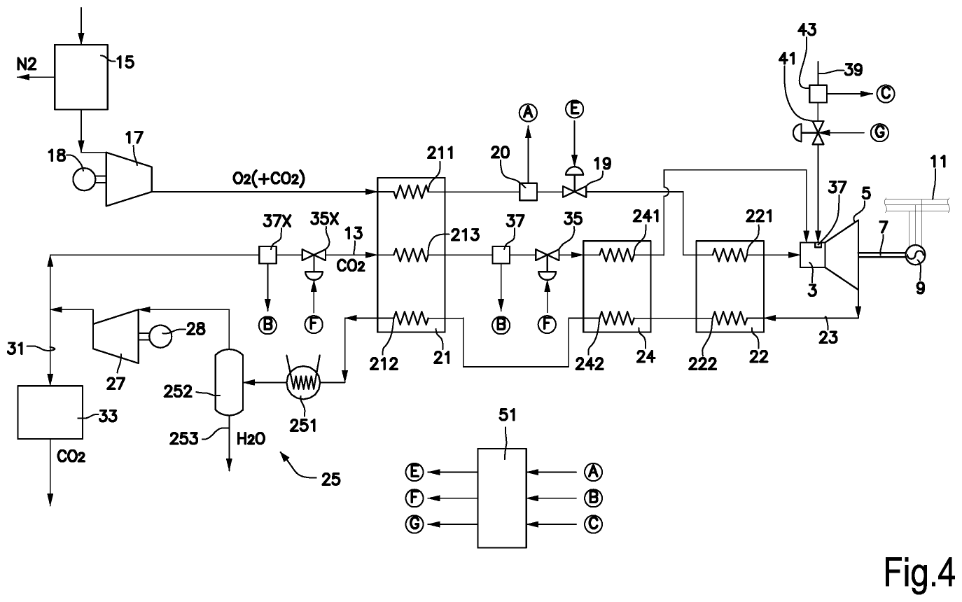

With continuing reference to FIGS. 1, 2 and 3, a further embodiment of an expander system is shown in FIG. 4. The same reference numbers designate similar or equivalent components as shown in FIGS. 1, 2 and 3. The system of FIG. 4 includes an additional third, intermediate-temperature heat exchanger.

More specifically, the expander system 1 of FIG. 4 includes a combustor 3 fluidly coupled to an expander or expander 5. The expander 5 generates mechanical power by expansion of a combustion gas and is drivingly coupled through a shaft 7 to an electric generator 9, electrically coupled to an electricity distribution grid 11. Other loads can be drivingly coupled to the expander 5 in addition to or instead of the electric generator 9, as already mentioned above.

An oxidant stream is supplied to the combustor 3 through an oxidant supply line 13. The oxidant stream, consisting mainly of oxygen or a mixture of oxygen and carbon dioxide, may be supplied by any oxidant source, such as an air separation unit 15.

The oxidant stream from the oxidant source 15 can be pressurized in an oxidant compressor 17 to achieve a pressure required for supplying the oxidant in the combustor 3. The oxidant compressor 17 can be driven by a driver, such as an electric motor 18. The electric motor 18 can be powered by electric power from the electricity distribution grid 11. In other embodiments, not shown, the oxidant compressor 17 can be driven directly by the expander 5. In such case the oxidant compressor 17 can be part of the load drivingly coupled to the expander shaft 7.

An oxidant control valve 19 is arranged along the oxidant supply line 13 between the oxidant compressor 17 and the combustor 3 and is adapted to control an oxidant flowrate through the oxidant supply line 13 towards the combustor 3. An oxidant flowmeter 20 can be arranged along the oxidant supply line 13, to detect the oxidant flowrate streaming through the oxidant supply line 13 to the combustor 3.

The oxidant stream supplied through the oxidant supply line 13 flows through a cold side 211 of a first, low-temperature heat exchanger 21 in heat exchange with combustion gas (flue gas) exhausted from the expander 5, to recover waste heat therefrom. The combustion gas exhausted from the expander 5 flows through a hot side 212 of the low-temperature heat exchanger 21.

The hot side 212 of the low-temperature heat exchanger 21 is fluidly coupled to a hot side 222 of a second, high-temperature heat exchanger 22 arranged upstream of the low-temperature heat exchanger 21 with respect to the direction of flow of the combustion gas. Differently from the previously described exemplary embodiments, however, between the low-temperature heat exchanger 21 and the high-temperature heat exchanger 22 a third, intermediate-temperature heat exchanger 24 is provided. As will be described in more detail below, the combustion gas stream flows sequentially through the hot side 222 of the high-temperature heat exchanger 22, the hot side 242 of the intermediate-temperature heat exchanger 24 and finally the hot side 212 of the low-temperature heat exchanger 21.

The hot side 222 of the high-temperature heat exchanger 22 is fluidly coupled to the discharge of the expander 5 through a combustion gas discharge line 23. The high-temperature heat exchanger 22 further includes a cold side 221, which has an inlet fluidly coupled to the outlet of the cold side 211 of the low-temperature heat exchanger 21 and an outlet which is fluidly coupled to the combustor 3.

The expanded combustion gas exhausted from the expander 5 exchanges heat against the oxidant stream that flows in the oxidant supply line 13, such that waste heat contained in the combustion gas exhausted from the expander 5 is at least partly recovered and used to heat the oxidant stream prior to entering the combustor 3.

In detail, the oxidant supply line 13 extends sequentially through the cold side 211 of the low-temperature heat exchanger 21 and through the cold side 221 of the high-temperature heat exchanger 22 prior to connecting to the combustor 3. In this way, oxidant from the oxidant source 15 is partially heated by waste heat recovered from the combustion gas (flue gas) streaming from the expander 5 by heat exchange in the low-temperature heat exchanger 21, and is further heated to a higher temperature by waste heat recovered from the combustion gas in the high-temperature heat exchanger 22.

The oxidant control valve 19 is located between the low-temperature heat exchanger 21 and the high-temperature heat exchanger 22, such that oxidant flowing through the oxidant control valve 19 is still at a relatively low temperature.

Moreover, since the oxidant control valve 19 is arranged downstream of the low-temperature heat exchanger 21 and upstream of the high-temperature heat exchanger 22, the total volume of oxidant contained in the oxidant supply line 13 downstream of the oxidant control valve 19, between this latter and the combustor 3, is smaller than if the whole heat were recovered in a single or multiple waste heat recovery heat exchanger arranged entirely downstream the oxidant control valve 19. This results in beneficial effects in terms of expander control and operability during transients, specifically in terms of reaction times to load variations.

The outlet of the hot side 212 of the low-temperature heat exchanger 21 is fluidly coupled to a water removal arrangement 25, adapted to remove water from the cooled combustion gas discharged from the hot side 212 of the low-temperature heat exchanger 21. In the schematic of FIG. 4, the water removal arrangement 25 comprises a condenser 251 and a water/gas separator 252. The combustion gas flowing through the condenser 251 is chilled, such that steam contained in the combustion gas condenses, separates from the gas in the water/gas separator 252 and is removed through a water removal line 253.

The chilled combustion gas from the water/gas separator 252 is compressed by a combustion gas compressor 27 and split into a first chilled combustion gas stream and a second chilled combustion gas stream. The combustion gas compressor 27 can be driven by the expander 5 or by a driver 28, such as an electric motor, which can be powered by electric power from the electricity distribution grid 11, for instance.

The first chilled combustion gas stream delivered by the water/gas separator 25 is recycled towards the low-temperature heat exchanger 21, the additional intermediate-temperature heat exchanger 24 and the combustor 3 through a recycle line 29. The recycle line 29 branches from a combustion gas removal line 31. In the embodiment of FIG. 4 the combustion gas removal line 31 is fluidly coupled to a carbon dioxide capturing unit 33, which processes a second chilled combustion gas stream delivered from water/gas separator 252, e.g., to store carbon dioxide and avoid discharge thereof in the environment.

The first chilled combustion gas stream, which is recycled through the recycle line 29, streams through a recycle cold side 213 of the low-temperature heat exchanger 21 in heat exchange with the hot side 212 of the low-temperature heat exchanger 21, to remove waste heat from the hot combustion gas exhausted from the expander 5 and flowing through the hot side 212 of the low-temperature heat exchanger 21. The partly heated recycled combustion gas stream discharged from the recycle cold side 213 of the low-temperature heat exchanger 21 streams through a recycle cold side 241 of the intermediate-temperature heat exchanger 24 to remove further waste heat from the combustion gas streaming through a hot side 242 of the intermediate-temperature heat exchanger 24. Finally, the heated recycle combustion gas is delivered from the recycle cold side 241 of the intermediate-temperature heat exchanger 24 to the combustor 3, where it is blended with the oxidant delivered through the oxidant supply line 13.

The flowrate of combustion gas recycled through the recycle line 29 can be adjusted by a recycling combustion gas control valve 35. A recycling combustion gas flowmeter 37 can be provided along the recycle line 29, to detect the flowrate of combustion gas recycling towards the combustor 3. In FIG. 4 the combustion gas flowmeter 37 and the combustion gas control valve 35 are arranged between the low-temperature heat exchanger 21 and the intermediate-temperature heat exchanger 24. Alternatively, the combustion gas flowmeter and the combustion gas control valve can be arranged upstream of the low-temperature heat exchanger 21, as shown at 37X. 35X.

The oxidant stream fed to the combustor 3 through the oxidant supply line 13 and the recycled combustion gas supplied to the combustor 3 through the recycle line 29 are mixed with fuel, for instance a gaseous fuel, supplied to one or more fuel nozzles 37 in the combustor 3, through a fuel supply line 39. A fuel control valve 41 along the fuel supply line 39 is adapted to adjust the flowrate of fuel delivered to the combustor 3. A fuel flowmeter 43 along the fuel supply line 39 can detect the flowrate of the fuel supplied to the combustor 3.

Efficient waste heat recovery from the combustion gas exhausted from the expander 5 is achieved by the three heat exchangers 21, 22 and 24. Performing oxidant heating in two sequentially arranged low-temperature heat exchanger 21 and high-temperature heat exchanger 22 enhances control and operability of the expander 5, as the volume between the oxidant control valve 19 and the combustor 3 is minimized.

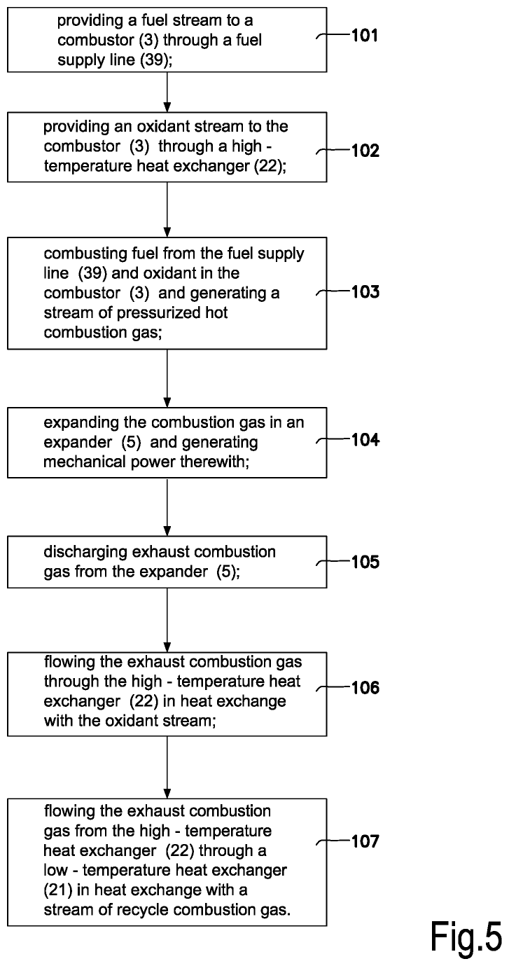

FIG. 5 illustrates a flowchart summarizing the main steps of methods performed by the above-described embodiments of the oxy-fuel turbine or expander system. Specifically, the method includes the following steps: providing a fuel stream to a combustor 3 through a fuel supply line 39, see step 101; providing an oxidant stream to the combustor 3 through a high-temperature heat exchanger 22, see step 102. As a further step fuel from the fuel supply line 39 and oxidant in the combustor 3 are combusted to generate a stream of pressurized hot combustion gas, see step 103. In step 104 the combustion gas is expanded in the expander or turbine 5 and mechanical power is generated therewith. Step 105 provides for discharging exhaust combustion gas from the expander 5. The exhaust combustion gas then flows through the high-temperature heat exchanger 22 in heat exchange with the oxidant stream, see step 106. Finally, step 107 provides for flowing the exhaust combustion gas from the high-temperature heat exchanger 22 through a low-temperature heat exchanger 21 in heat exchange with a stream of recycle combustion gas.

Exemplary embodiments have been disclosed above and illustrated in the ac-companying drawings. It will be understood by those skilled in the art that various changes, omissions and additions may be made to that which is specifically disclosed herein without departing from the scope of the invention as defined in the following claims.

1. An oxy-fuel expander system comprising:
a combustor adapted to combust a fuel and an oxidant and generate pressurized hot combustion gas;
an expander fluidly coupled to the combustor and rotated by expansion of the pressurized hot combustion gas from the combustor;
a high-temperature heat exchanger fluidly coupled to the expander;
a low-temperature heat exchanger fluidly coupled to the high-temperature heat exchanger;
wherein a hot side of the high-temperature heat exchanger and a hot side of the low-temperature heat exchanger are fluidly coupled in sequence and are adapted to receive and cool expanded combustion gas exhausted from the expander;
an oxidant supply line adapted to supply oxidant to the combustor through a cold side of the high-temperature heat exchanger;
wherein in use the oxidant streaming through the high-temperature heat exchanger is in heat exchange with combustion gas exhausted from the expander;
a fuel supply line adapted to supply fuel to the combustor; and
a combustion gas compressor adapted to compress combustion gas streaming from the low temperature heat exchanger;
a recycle line for recycling a combustion gas stream from the combustion gas compressor through the low-temperature heat exchanger and to the combustor;
wherein the recycle line extends through a recycle cold side of the low-temperature heat exchanger in heat exchange with the hot side of the low-temperature heat exchanger and
a first oxidant control valve in the oxidant supply line upstream of the high-temperature heat exchanger.

2. The system of claim 1, wherein the oxidant supply line and the recycle line are separated from one another and fluidly coupled to the combustor.

3. The system of claim 1, wherein the recycle line further extends sequentially through a recycle cold side of the high-temperature heat exchanger in heat exchange with the hot side of the high-temperature heat exchanger.

4. The system of claim 1, wherein the first oxidant control valve is positioned between the low-temperature heat exchanger and the high-temperature heat exchanger; and wherein the oxidant supply line extends sequentially through the low-temperature heat exchanger and the high-temperature heat exchanger.

5. The system of claim 4, further comprising an oxidant bypass supply line branched from the oxidant supply line between the low-temperature heat exchanger and the first oxidant control valve, bypassing the high-temperature heat exchanger and adapted to supply oxidant to the combustor; and
wherein a second oxidant control valve is positioned in the oxidant bypass line.

6. The system of claim 5, wherein the oxidant bypass supply line is further fluidly coupled to one of: the oxidant supply line between the high-temperature heat exchanger and the combustor;
the fuel supply line and
the combustor.

7. The system of claim 1, wherein:
the first oxidant control valve is positioned between the low-temperature heat exchanger and the high-temperature heat exchanger;
the oxidant supply line extends sequentially through the low-temperature heat exchanger and the high-temperature heat exchanger;
the system further comprises an intermediate-temperature heat exchanger having a hot side sequentially arranged between the hot side of the high-temperature heat exchanger and the hot side of the low-temperature heat exchanger;
a combustion gas exhaust line extends from the expander sequentially through the hot side of the high-temperature heat exchanger, the hot side of the intermediate-temperature heat exchanger and the hot side of the low-temperature heat exchanger; and
a cold side of the intermediate-temperature heat exchanger is fluidly coupled to the recycle cold side of the low-temperature heat exchanger and to the combustor, such that recycled combustion gas is heated by heat exchange with combustion gas exhausted from the expander in the intermediate-temperature heat exchanger and in the low-temperature heat exchanger.

8. A method for operation of an expander system, the method comprising the following steps:
providing a fuel stream to a combustor through a fuel supply line;
providing an oxidant stream to the combustor through an oxidant supply line extending through a high-temperature heat exchanger;
combusting fuel from the fuel supply line and oxidant in the combustor and generating a stream of pressurized hot combustion gas;
expanding the combustion gas in an expander and generating mechanical power therewith;
discharging exhaust combustion gas from the expander;
flowing the exhaust combustion gas through the high-temperature heat exchanger in heat exchange with the oxidant stream;
flowing the exhaust combustion gas from the high-temperature heat exchanger through a low-temperature heat exchanger in heat exchange with a stream of recycled combustion gas; and
adjusting the oxidant flow by a first oxidant control valve arranged in the oxidant supply line upstream of the high-temperature heat exchanger.

9. The method of claim 8, further comprising the step of flowing the oxidant stream through the low-temperature heat exchanger in heat exchange with the exhaust combustion gas, the low-temperature heat exchanger being arranged upstream of the high-Attorney temperature heat exchanger with respect to an oxidant flow direction in the oxidant supply line.

10. The method of claim 8, wherein the first oxidant control valve is arranged in the oxidant supply line between the low-temperature heat exchanger and the high-temperature heat exchanger.

11. The method of claim 8, further comprising the step of supplying a second oxidant stream toward the combustor through a second oxidant control valve located in an oxidant bypass line;
wherein the oxidant bypass line branches from the oxidant supply line downstream of the low-temperature heat exchanger and bypasses the high-temperature heat exchanger.

12. The method of claim 8, further comprising the step of flowing the stream of recycled combustion gas through an intermediate-temperature heat exchanger, in heat exchange with combustion gas from the high-temperature heat exchanger.
